(19) United States
(12) Patent Application Publication
(10) Pub. No.: US 2019/0228083 A1
(43) Pub. Date: Jul. 25, 2019

(54) MANAGING APPLICATION RESOURCES BASED ON FUNNELS APPLIED IN SITE NAVIGATION

(71) Applicant: International Business Machines Corporation, Armonk, NY (US)

(72) Inventors: Peter Yim, Raleigh, NC (US); Don Rota, Leominster, MA (US); William Nicol, II, Durham, NC (US); Jeffrey Antley, New Hill, NC (US)

(21) Appl. No.: 15/876,414

(22) Filed: Jan. 22, 2018

(51) Int. Cl. G06F 17/30; H04L 29/08; G06Q 30/02; H04L 12/26

(52) U.S. Cl. CPC G06F 17/3089; H04L 43/08; G06Q 30/0201; H04L 67/02

(57) ABSTRACT

A computer implemented method and system for managing resources for nodes of a website that belong to at least one funnel for the website, includes identifying two or more funnels for the website, identifying nodes that belong to one or more of the funnels, determining a number of funnels each node belongs to, monitoring use of the nodes by website visitors, determining a probability metric that a user will visit one or more of the nodes based on the number of funnels each node belongs to and the use by website visitors of the nodes and proportionally allocating resources for one or more of the nodes based on the probability metric. The method and system may be implemented as a feature of or a plug-in for a website analytics tool.

### BACKGROUND OF THE INVENTION

This disclosure is directed to computers, and computer applications, and more particularly to computer-implemented methods and systems for managing resources for nodes of a website that belong to at least one funnel for the website.

Data-driven websites have become common in recent years. One measure of the success of a data-driven website is to examine the analytics data to see if the users follow certain expected funnels or journeys.

A funnel as defined herein, is a path through a website with a desired outcome. For example, an e-commerce site might have a simple funnel “HOME PAGE>PRODUCT INFORMATION>PRODUCT ADDED TO CART>PRODUCT PURCHASED

If users are not following the desired funnel(s), a website author might alter the website navigation to try to get users to follow the expected funnel(s). However, problems occur due to the increase in traffic to the pages in the funnel caused by the users following the desired funnel(s).

### SUMMARY OF THE INVENTION

One embodiment of a computer implemented method for managing resources for nodes of a website that belong to at least one funnel for the website, includes identifying two or more funnels for the website, identifying nodes that belong to one or more of the funnels, determining a number of funnels each node belongs to, monitoring use of the nodes by website visitors, determining a probability metric that a user will visit one or more of the nodes based on the number of funnels each node belongs to and the use by website visitors of the nodes and proportionally allocating resources for one or more of the nodes based on the probability metric.

A system that includes one or more processors and program instructions, stored on one or more non-transitory computer-readable storage media, which when implemented by the one or more processors, cause the computer system to perform one or more methods described herein also may be provided. In one embodiment, the program instructions are a feature of or a plug-in for a website analytics tool.

A computer readable storage medium storing a program of instructions executable by a machine to perform one or more methods described herein also may be provided.

The methods, systems and computer program product described herein provides application resource management that solves the problem of increased in traffic to the pages in the funnel by enhanced utilization of the web pages that are part of the funnels in order for the web pages to handle the expected traffic pattern.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram of one embodiment of the method disclosed in this specification.

FIG. 2 is a block diagram of one embodiment of the system disclosed in this specification.

FIG. 3 is a block diagram of an exemplary computing system suitable for implementation of the embodiments disclosed in this specification.

### DETAILED DESCRIPTION OF PREFERRED EMBODIMENTS

The invention performs predictive application resource management based on site navigation to provide enhanced resource utilization. The navigation used for the predictive application resource management is created based on traffic funnels gathered from the website. For each website, there may be multiple funnels of user traffic in action. In one embodiment, nodes in funnels are intercepted and metered. Nodes are comprised of web pages and/or web applications. Nodes that are part of a funnel due to higher traffic volume are used as a resource enhancement guide. In one embodiment, nodes that belong to more than one funnel are used as a resource enhancement guide. Web pages served by web applications need to be utilization enhancement because of the added traffic.

In one embodiment, the user traffic patterns within the site are followed using an assigned funnel navigation map. By using the assigned funnel navigation map, the system predicts which web pages users will follow more frequently. Based on this prediction, the system determines where to place the most resources. In one embodiment, the resource management may include CPU priority, additional RAM, virtual instances, db connection pools, number of nodes in a cluster and the like. Increasing resources onto a funnel that the user is likely to choose next will improve the user journey experience and results in a more efficient and cost effective allocation of resources.

In one embodiment, the method includes the steps of identifying all the nodes that belong to various funnels. For each node, count how many funnels the node belongs to. The method further includes scaling up the resources of these nodes in the funnels. Since the weight of a node is known from the number of funnels, the system proportionally scales the resources of the web applications that serve the web pages in preparation of the high traffic.

Resources may exist on one machine or over several, depending on the where the website lives. In one embodiment, a resource controller will cross-reference the backend equipment and the website URLs for each site. The resource controller will remotely enhance or commit extra resources for any backend servers, based on the most favored funnel sequences based on where the user is now.

The web page resource management provides numerous benefits. If a user is following the most common funnels of traffic, they will always be given resources that keep them “in the high speed lane”. Users would not see a degradation of a web page response time since the page they're on is ‘in the funnel’. This enhances the overall user experience. Faster response times prevent users from absconding the website. Prioritization provides a cost savings to the site, as only resources that are likely to be used will be ‘spun-up’, or preloaded to be running at a higher capacity. Lower priority funnel pages and equipment will be demoted and given a lower priority. Those low ranking (demoted) resources will consume fewer resources which will effect a cost savings, through lower power demands. Over time, lower ‘measured’ traffic assets/resources can be decommissioned, which also brings a cost savings.

In one example, the users navigate through a first funnel of nodes A to C to K or through a second funnel of nodes D to C to E. In this example both funnels flows go through node C. As such, the server and services that host Web Page C are granted more resources based on the flow metrics.

In one embodiment, the method applies to funnels defined in an analytics tool. Using the defined funnels, allocation of resources are both anticipated and predicted. The method uses the user traffic information and funnels as parameters to allocate resources and does not focus on tracking as known in the prior art. The method anticipates the traffic coming in from defined funnels and does not focus on the caching of the web content itself as known in the prior art. In the context of funnels defined in analytics tools, the method reserves resources for the defined funnels and predicts the expected traffic downstream in the funnels. The method provides enhanced utilization of the funnel resources defined by funnels based on expected and live user traffic. The method and system uses the defined funnels to prepare resources for expected traffic.

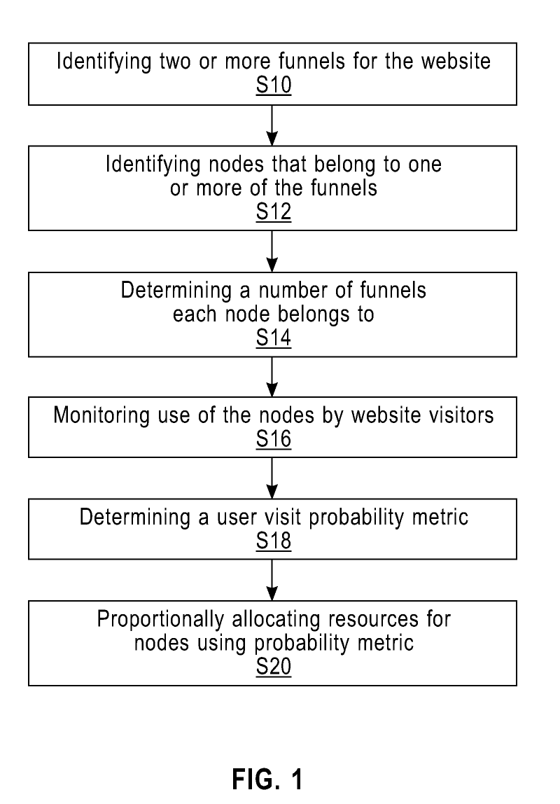

In one embodiment, as shown in FIG. 1, a computer implemented method for managing resources for nodes of a website that belong to at least one funnel for the website, includes step S10 of identifying two or more funnels for the website, step S12 of identifying nodes that belong to one or more of the funnels, step S14 of determining a number of funnels each node belongs to, step S16 of monitoring use of the nodes by website visitors, step S18 of determining a probability metric that a user will visit one or more of the nodes based on the number of funnels each node belongs to and the use by website visitors of the nodes and step S20 of proportionally allocating resources for one or more of the nodes based on the probability metric.

In one embodiment, step S20 of proportionally allocating resources includes identifying one or more of the nodes as a high-visit node based on the probability metric, a high-visit node having a probability metric greater than a first threshold, and increasing resources for the one or more high-visit nodes of the website. In one embodiment, step S20 of proportionally allocating resources includes identifying one or more of the nodes as a low-visit node based on the probability metric, a low-visit node having a probability metric lower than a second threshold, the second threshold being lower than the first threshold, and decreasing resources for the one or more low-visit nodes of the website.

In one embodiment, the computer implemented method for managing resources includes dynamically increasing resources for a downstream node in a first funnel as users are traversing through the first funnel based on a number of users that are currently viewing an upstream node of the first funnel and the probability metric. In one embodiment, the method includes dynamically reducing resources for a downstream node in a first funnel as users are traversing through the first funnel based on a number of users that are currently viewing an upstream node of the first funnel and the probability metric.

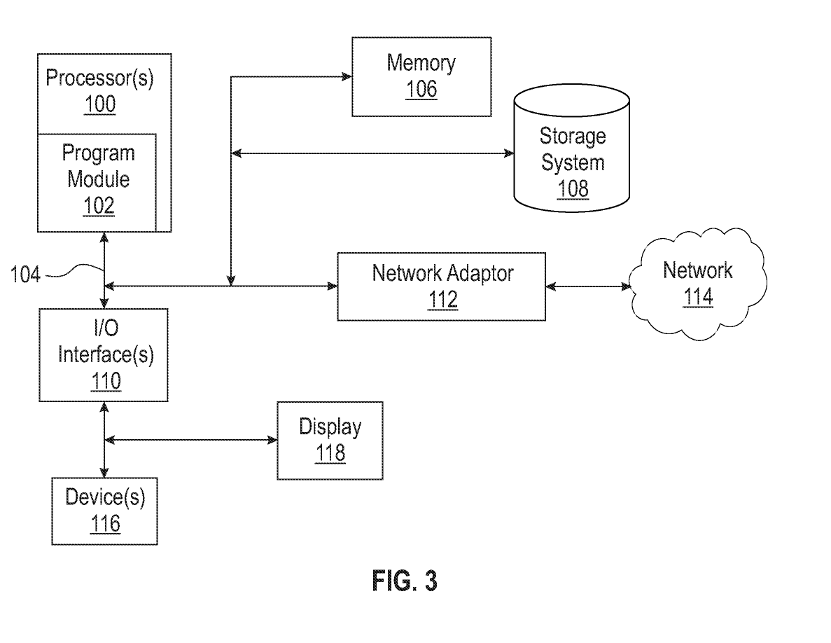

In one embodiment, the computer implemented method for managing resources is performed by a website analytics tool. In one embodiment, the website analytics tool monitors use by website visitors of funnel website nodes by monitoring one or more of user website node traffic navigation patterns and user website node response time. The website analytics tool may be implemented, in one embodiment, in program module 102 of FIG. 3, described later.

In one embodiment, the method and system makes sure that the system resources that support the web pages and applications can handle the expected traffic through funnels defined in an analytics tool. Since we know what the funnels are, and also knowing if any web pages/applications are part of multiple funnels, the analytics tool predictively adjusts the resources.

In one embodiment, in a preparation state before the funnels are online, enough resources to handle the traffic for all the web pages/apps that are part of a funnel are allocated. For web pages/apps that are part of more than one funnel, the resources are increased an amount depending on the number of funnels they are part of.

In a live state when the funnels are online, as the website analytics tool learns about the user traffic going through the various funnels over time, the resources can be adjusted depending on live user traffic. For example, if the website analytics tool knows a lot of users are going through web pages A, B, and C, but not so much D, E, and F, the website analytics tool will allocate more resources the funnel going through A, B, and C and reduce the resources for D, E, and F.

The methods and systems disclosed herein improves how resources should be allocated adequately using pre-defined nodes in funnels and live user traffic going through the funnels. If the website analytics tool knows that some of the funnels can have many nodes and tool knows there are limited resources but there is need to prepare for traffic going through these nodes. The website analytics tool dynamically allocates resources as users are traversing through the funnel. For example, for a funnel of nodes U, W, X, Y, and Z, if the tool knows there are a lot of users who are now at W, and that nodes X, Y and Z are next, and Y is a big app, since resources are limited, the tool will now deallocate some resources from U and add more to X and even more to Y. This way, users would perceive the site being responsive, and maintain a good user experience and possibly leads to 100% users going through the funnel.

In one embodiment, funnels are set up in the analytics tools; user traffic is logged and reflected visually in the analytics tool based on application system logs. The method and system may be implemented as an add-on or as a built-in feature in the analytics tools. In one embodiment, the tool controls the resources of these application systems defined in funnels. In one embodiment, an agent is deployed to the nodes so that the website analytics tool and the nodes can communicate with each other on statuses and control commands. In one embodiment, a constant feedback loop is in place to monitor resource allocation.

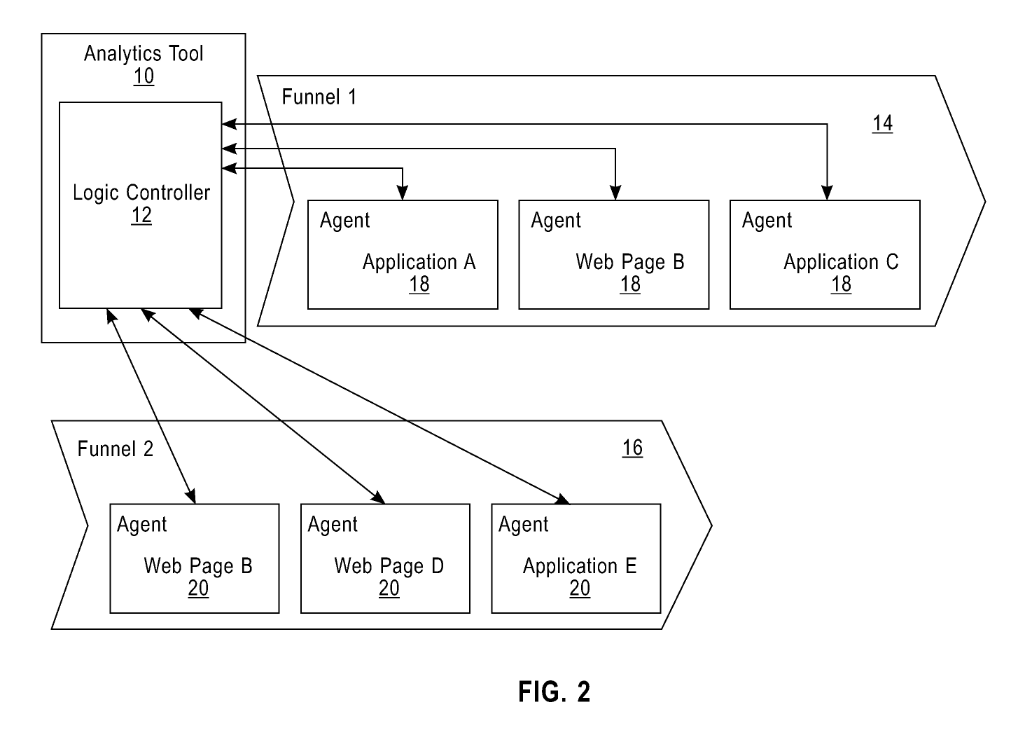

In one embodiment as shown in FIG. 2, a website analytics tool 10 includes a logic controller 12. There is a first funnel 14 and a second funnel 16 set up in the analytic tool 10. Funnel 1 has nodes 18 of Application A, Web Page B and Application C. Funnel 1 is the expected user navigation journey a data analyst expects the users will go through. Funnel 2 has nodes 20 of Web Page B, Web Page D and Application E. Each node in these funnels has an agent attached to it so that the logic controller 12 built in the analytics tool 10 can communicate with the nodes. Also, each node takes up computer resources, such as CPU, RAM and disk space.

User traffic information from each node 18 and 20 is communicated back to the logic controller 12 based on various web logs. Web Page B belongs to both Funnel 1 and 2. Therefore, the logic controller 12 has instructed Web Page B to reserve more resources in anticipation of higher user traffic. Now as users travel down the two expected funnels, the user traffic is being reported by the nodes 18 and 20. The tool 10 sees a high traffic going through Web Page B. The tool 10 also realizes that Web Page D and Application E in Funnel 2 share the same computer resources, Since Web Page D is the next node after Web Page B in Funnel 2, resources in Application E will be swapped to handle the expected traffic to Web Page D. Then as traffic is slowly trickling down to Application E, Web Page D is told to relieve its resources and give them to Application E by the logic controller 12. The allocation and deallocation operations of resources are the responsibility of an operation system. The analytics tool 10 is only responsible for issuing control commands to tell the residing agents which communicate with the operation system to allocate or deallocate the amount of resources, such as doubling or halving the resources based on user traffic and user perceived response time. The tool 10 uses probability metrics, such as user traffic and user perceived response time, both of which can be logged by web servers. However, analytics tool can use any possible parameters as metrics as user's devices may evolve from desktop, to portable devices, to smart watches,

In one embodiment, instead of using funnels defined by a data analyst in an analytic tool, the method and system can use the navigation links of a website's web page/applications created by webmasters to figure out the pre-defined funnels through various nodes, and then import them into the analytic tool. Then, the created navigation diagram can be used to enhance the resource allocation of these nodes.

In one embodiment, the computer implemented method for managing resources includes identifying two or more funnels for the website from one or more funnel navigation maps created from a combination of user website node navigation patterns for the website and common interests of the website users. In one embodiment, the system and method includes mapping funnels or journeys to website navigation. The system automates the process of applying funnels curated based on data to a website navigation bar. The funnels can be curated manually in an analytics tool or automatically by existing tools. The funnels may be created and personalized based on aggregate users' patterns and common interests. In one embodiment the system applies the funnels automatically to the website in an analytic tool. In one embodiment, creation of the funnel navigation map is a feature of, or a plugin for, existing analytic tools.

Traditionally, the genesis of website navigation is based on some pre-conceived notions of how users will move from page to page in the website. An administrator or a strategist of a website would validate the navigation through analytics tools and create many funnels in the tools to see if the users do follow these funnels. If the success rate of a funnel is subpar, one strategy is to update the navigation of the pages in the funnel.

In one embodiment, the analytic tool will identify the pages in the funnel, identify the users that may be considered in the funnel (same interests, etc), convert funnel into html/js code snippets to create a navigation map of pages in the funnel. The navigation map is presented to the dynamically to the user. The navigation map is created automatically by the analytic tool. The funnels can tested without the help of a web author to update the navigation map of the pages

FIG. 3 illustrates a schematic of an example computer or processing system that may implement the method for managing resources for nodes of a website that belong to at least one funnel for the website in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processor 100 may include a program module 102 that performs the methods described herein. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a non-transitory computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for managing resources for nodes of a website that belong to at least one funnel for the website, the method comprising:
identifying two or more funnels for the website;
identifying nodes that belong to one or more of the funnels;
determining a number of funnels each node belongs to;
monitoring use of the nodes by website visitors;
determining a probability metric that a user will visit one or more of the nodes based on the number of funnels each node belongs to and the use by website visitors of the nodes; and
proportionally allocating resources for one or more of the nodes based on the probability metric.

2. The computer implemented method for managing resources of claim 1, wherein proportionally allocating resources includes identifying one or more of the nodes as a high-visit node based on the probability metric, a high-visit node having a probability metric greater than a first threshold, and increasing resources for the one or more high-visit nodes of the website.

3. The computer implemented method for managing resources of claim 1, wherein proportionally allocating resources includes identifying one or more of the nodes as a low-visit node based on the probability metric, a low-visit node having a probability metric lower than a second threshold, the second threshold being lower than the first threshold, and decreasing resources for the one or more low-visit nodes of the website.

4. The computer implemented method for managing resources of claim 2, further comprising dynamically increasing resources for a downstream node in a first funnel as users are traversing through the first funnel based on a number of users that are currently viewing an upstream node of the first funnel and the probability metric.

5. The computer implemented method for managing resources of claim 3, further comprising dynamically reducing resources for a downstream node in a first funnel as users are traversing through the first funnel based on a number of users that are currently viewing an upstream node of the first funnel and the probability metric.

6. The computer implemented method for managing resources of claim 1, wherein each of the steps are performed by a website analytics tool.

7. The computer implemented method for managing resources of claim 1, wherein identifying two or more funnels for the website are identified from one or more funnel navigation maps created from a combination of user website node navigation patterns for the website and common interests of the website users.

8. The computer implemented method for managing resources of claim 1, wherein monitoring use by website visitors of funnel website nodes includes monitoring one or more of user website node traffic navigation patterns and user website node response time.

9. A computer system for managing resources for nodes of a website that belong to at least one funnel for the website, comprising:
one or more computer processors;
one or more non-transitory computer-readable storage media;
program instructions, stored on the one or more non-transitory computer-readable storage media, which when implemented by the one or more processors, cause the computer system to perform the steps of:
identifying two or more funnels for the website;
identifying nodes that belong to one or more of the funnels;
determining a number of funnels each node belongs to;
monitoring use of the nodes by website visitors;
determining a probability metric that a user will visit one or more of the nodes based on the number of funnels each node belongs to and the use by website visitors of the nodes; and
proportionally allocating resources for one or more of the nodes based on the probability metric.

10. The computer system for managing resources of claim 9, wherein the program instructions are a feature of or a plug-in for a website analytics tool.

11. The computer system for managing resources of claim 10, wherein the nodes of the website are one or more of a web page and a website application.

12. The computer system for managing resources of claim 11, wherein the nodes of the website include an agent module for communicating with a controller of the website analytics tool.

13. The computer system for managing resources of claim 12, wherein the controller monitors use by website visitors of the nodes by monitoring one or more of user node traffic navigation patterns and user node response time.

14. The computer system for managing resources of claim 15, wherein,
the controller proportionally allocates resources by identifying one or more of the nodes as a high-visit node based on the probability metric, a high-visit node having a probability metric greater than a first threshold, and sending one or more control commands for increasing resources to the agent modules of the one or more high-visit nodes of the website, and
the controller proportionally allocates resources by identifying one or more of the nodes as a low-visit node based on the probability metric, a low-visit node having a probability metric lower than a second threshold, the second threshold being lower than the first threshold, and sending one or more control commands for decreasing resources to the agent modules of the one or more low-visit nodes of the website.

15. The computer system for managing resources of claim 14, wherein,
the controller dynamically increases resources for a downstream node in a first funnel as users are traversing through the first funnel based on a number of users that are currently viewing an upstream node of the first funnel and the probability metric, and
the controller dynamically reduces resources for a downstream node in a first funnel as users are traversing through the first funnel based on a number of users that are currently viewing an upstream node of the first funnel and the probability metric.

16. A computer program product comprising:
program instructions on a computer-readable storage medium, where execution of the program instructions using a computer causes the computer to perform a method for managing resources for nodes of a website that belong to at least one funnel for the website, comprising:
identifying two or more funnels for the website;
identifying nodes that belong to one or more of the funnels;
determining a number of funnels each node belongs to;
monitoring use of the nodes by website visitors;
determining a probability metric that a user will visit one or more of the nodes based on the number of funnels each node belongs to and the use by website visitors of the nodes; and
proportionally allocating resources for one or more of the nodes based on the probability metric.

17. The computer program product for managing resources of claim 1, wherein proportionally allocating resources includes identifying one or more of the nodes as a high-visit node based on the probability metric, a high-visit node having a probability metric greater than a first threshold, and increasing resources for the one or more high-visit nodes of the website.

18. The computer program product for managing resources of claim 1, wherein proportionally allocating resources includes identifying one or more of the nodes as a low-visit node based on the probability metric, a low-visit node having a probability metric lower than a second threshold, the second threshold being lower than the first threshold, and decreasing resources for the one or more low-visit nodes of the website.

19. The computer program product for managing resources of claim 2, further comprising dynamically increasing resources for a downstream node in a first funnel as users are traversing through the first funnel based on a number of users that are currently viewing an upstream node of the first funnel and the probability metric.

20. The computer program product for managing resources of claim 3, further comprising dynamically reducing resources for a downstream node in a first funnel as users are traversing through the first funnel based on a number of users that are currently viewing an upstream node of the first funnel and the probability metric.
